(19) United States
(12) Patent Application Publication
(10) Pub. No.: US 2026/0153912 A1
(43) Pub. Date: Jun. 4, 2026

(54) TEMPERATURE THROTTLING METHOD OF STORAGE DEVICE

(71) Applicant: Samsung Electronics Co., Ltd., Suwon-si (KR)

(72) Inventors: Seulgi SHIN, Suwon-si (KR); Geunsoo KIM, Suwon-si (KR); Minuk KIM, Suwon-si (KR); Euiseok SIM, Suwon-si (KR); Chulwon YANG, Suwon-si (KR)

(73) Assignee: Samsung Electronics Co., Ltd., Suwon-si (KR)

(21) Appl. No.: 19/219,333

(22) Filed: May 27, 2025

(30) Foreign Application Priority Data
Dec. 3, 2024 (KR) 10-2024-0177419

(51) Int. Cl. G06F 1/20

(52) U.S. Cl. CPC G06F 1/20

(57) ABSTRACT

A temperature throttling method of a storage device includes monitoring current performance of a memory device, the memory device operating in response to input/output commands respectively included in a plurality of streams, determining, based on a current temperature of the storage device, a reference performance and a reference delay value for each of the plurality of streams, determining, based on the current performance, a weight for each of the plurality of streams, determining a target delay value by reflecting the weight on the reference delay value for each of the plurality of streams, and applying the weight for which the reference performance is measured in each of the plurality of streams.

### CROSS-REFERENCE TO RELATED APPLICATIONS

This application claims benefit of priority to Korean Patent Application No. 10-2024-0177419 filed on Dec. 3, 2024 in the Korean Intellectual Property Office, the disclosure of which is incorporated herein by reference in its entirety.

### BACKGROUND

The present inventive concepts relate to a temperature throttling method of a storage device.

A storage device may include a memory controller and a memory device. The memory controller may receive an input/output command from a host or generate an input/output command. The memory controller may further transmit an input/output command to the memory device, and an input/output operation corresponding to the input/output command may be performed in the memory device. For example, the memory device may perform an input/output operation of storing and/or erasing data and/or of reading stored data and transmitting the same externally. However, if the internal temperature of the storage device excessively rises, the memory device may not be able to stably perform the input/output operation. Here, the memory controller may perform a dynamic thermal throttling (DTT) operation of controlling input/output throughput of the memory device, etc., to lower the internal temperature of the storage device.

### SUMMARY

An aspect of the present inventive concepts is to provide a method of monitoring input/output throughput of each of a plurality of streams of a memory device and reducing the number of input/output commands transmitted by a memory controller in each of the plurality of streams in a unit time differently from each other to control the input/output throughput of each of the plurality of streams of the memory device, thereby improving temperature control efficiency of a storage device.

According to an aspect of the present inventive concepts, a temperature throttling method of a storage device includes: monitoring current performance of a memory device, the memory device operating in response to input/output commands respectively included in a plurality of streams; determining, based on a current temperature of the storage device, a reference performance and a reference delay value for each of the plurality of streams; determining, based on the current performance, a weight for each of the plurality of streams; determining a target delay value, for each of the plurality of streams, by reflecting the weight on the reference delay value; and applying the weight, for which the reference performance is measured, in each of the plurality of streams.

According to an aspect of the present inventive concepts, a temperature throttling method of an automotive storage device includes: determining, based on a current temperature of the automotive storage device, a reference performance ratio for each of a plurality of streams; determining a reference performance by multiplying a current performance by the reference performance ratio for each of the plurality of streams; determining a reference delay value for each of the plurality of streams based on a difference between the current performance and the reference performance; determining a weight for each of the plurality of streams based on a ratio of the current performance corresponding to each of the plurality of streams to a sum of current performances of the plurality of streams; determining a target delay value for each of a corresponding stream, of the plurality of streams, by applying the weight to the reference delay value; and applying, for each of the plurality of streams, the target delay value to the corresponding stream.

According to an aspect of the present inventive concepts, a temperature throttling method of a storage device includes: starting a throttling of the storage device based on a determination that a current temperature of the storage device is higher than a reference temperature; monitoring input/output throughputs for each of a plurality of streams; determining delay times of input/output transmission periods applied to each of the plurality of streams by reflecting the current temperature of the storage device and the input/output throughputs for each of the plurality of streams; applying a delay time, of the delay times, to a corresponding stream of the plurality of streams; and terminating throttling for the storage device based on a determination that the current temperature of the storage device is lower than the reference temperature, wherein at least a portion of the delay times of the input/output transmission periods applied to the plurality of streams differ from at least a portion of a remainder of the delay times of the input/output transmission periods.

According to an aspect of the present innovative concepts, a storage device may include a memory device, a memory controller configured to control the memory device, and a temperature sensor configured to detect a current temperature of the memory device. The memory controller may be configured control an operation of the memory device based on input/output commands respectively included in a plurality of streams; monitor a current performance of the memory device operating in response to the input/output commands; determining, based on the current temperature of the storage device, a reference performance and a reference delay value for each of the plurality of streams; determine, based on the current performance, a weight for each of the plurality of streams; determine a target delay value, for each of the plurality of streams, by reflecting the weight on the reference delay value; and apply the weight, for which the reference performance is measured, in each of the plurality of streams.

The memory controller may be further configured to delay a transmission period of at least one of the input/output commands by applying the target delay value to a corresponding stream from among the plurality of streams.

The memory device may include different types of memory cells; and the types of memory cells may include at least one of single level cell, multiple level cell, triple level cell, or quadruple level cell.

### BRIEF DESCRIPTION OF DRAWINGS

The above and other aspects, features, and advantages of the present inventive concepts will be more clearly understood from the following detailed description, taken in conjunction with the accompanying drawings, in which:

FIG. 1 is a block diagram schematically illustrating a host-storage system according to at least one example embodiment of the present inventive concepts;

FIG. 2 is a diagram illustrating an operation of controlling the temperature of a storage device according to at least one example embodiment of the present inventive concepts;

FIG. 3 is a block diagram schematically illustrating a memory block according to at least one example embodiment of the present inventive concepts;

FIG. 4 is a diagram illustrating a 3D V-NAND structure applicable to a storage device according to at least one example embodiment of the present inventive concepts;

FIG. 5 is a diagram illustrating a threshold voltage distribution of a memory cell according to at least one example embodiment of the present inventive concepts;

FIG. 6 is a block diagram schematically illustrating a throttling controller according to at least one example embodiment of the present inventive concepts;

FIG. 7 is a flowchart illustrating throttling performance of a throttling controller according to at least one example embodiment of the present inventive concepts;

FIG. 8 is a diagram illustrating a performance ratio by stream according to a temperature range of a storage device according to at least one example embodiment of the present inventive concepts;

FIG. 9 is a diagram illustrating calculation of a target delay value by stream according to at least one example embodiment of the present inventive concepts; and

FIGS. 10 and 11 are diagrams illustrating transmission periods of input/output commands of embodiments of the present inventive concepts.

### DETAILED DESCRIPTION

Hereinafter, embodiments of the present inventive concepts will be described with reference to the accompanying drawings.

In the specification and drawings, functional elements that are configured to process at least one function or operation, unless indicated otherwise, may be realized by processing circuitry, such as hardware, software, or a combination of hardware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., unless indicated otherwise. The processing circuitry may further include electrical components (such as at least one of transistors, resistors, capacitors, etc.), and/or electronic circuits including said components. Further, the operations of the processing circuitry may be processed based on computer-implemented non-transient machine-readable instructions.

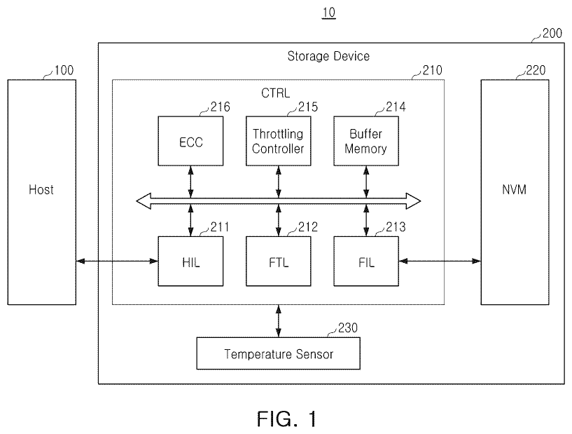

FIG. 1 is a block diagram schematically illustrating a host-storage system according to at least one example embodiment of the present inventive concepts.

A host-storage system 10 may include a host 100 and a storage device 200. In addition, the storage device 200 may include a memory controller 210, a memory device 220, and a temperature sensor 230. In at least one example, the host-storage system 10 may be included in an automotive device; however, the examples are not limited thereto.

The host 100 may include one or more electronic devices, such as portable electronic devices, such as mobile phones, MP3 players, laptop computers, electronic devices (such as desktop computers, game consoles, TVs, projectors, etc.), and/or the like. The host 100 may include at least one operating system (OS). The operating system may be configured to manage and control the overall functions and operations of the host 100. For example, in the case wherein the host-storage system 10 is included in the automotive device, the host 100 may be an automotive processor included in the automotive device.

The storage device 200 may include storage mediums configured to store data according to a request from the host 100. For example, in the case wherein the host-storage system 10 is included in the automotive device, the storage device 200 may be an automotive storage device included in the automotive device. The storage device 200 may include at least one of a solid state drive (SSD), an embedded memory, and a removable external memory. The storage device 200 may be configured to follow a corresponding standard. For example, if the storage device 200 includes an SSD, the storage device 200 may be a device that follows the nonvolatile memory express (NVMe) standard; and if the storage device 200 includes an embedded memory or an external memory, the storage device 200 may be a device that follows the universal flash storage (UFS) or embedded multimedia card (eMMC) standard. The host 100 and the storage device 200 may each be configured to generate packets (e.g., according to adopted standard protocols) and to transmit the same.

The memory device 220 may maintain stored data even when power is not supplied. For example, the memory device 220 may include a non-volatile memory. The memory device 220 may store data provided from the host 100 through a write operation and may output data stored in the memory device 220 through a read operation. The memory device 220 includes a plurality of memory blocks, each of the memory blocks including a plurality of pages, and each of the pages may include a plurality of memory cells connected to word lines. In at least one example embodiment of the present inventive concepts, the memory device 220 may be a flash memory, and data related to the operation of the automotive device may be stored in the memory device 220.

When the memory device 220 of the storage device 200 includes a flash memory, the flash memory may include at least one of a 2D NAND memory array or a 3D (or vertical) NAND (VNAND) memory array. As another example, the storage device 200 may include various other types of nonvolatile memories. For example, the storage device 200 may include at least one of magnetic RAM (MRAM), spin-transfer torque MRAM, conductive bridging RAM (CBRAM), ferroelectric RAM (FeRAM), phase RAM (PRAM), resistive RAM, or various other types of memory.

The memory controller 210 may be configured to control the memory device 220 in response to a request from the host 100. For example, the memory controller 210 may provide data read from the memory device 220 to the host 100 and write (program) data provided from the host 100 to the memory device 220.

In at least one example embodiment, the memory controller 210 may include a host interface layer (HIL) 211, a flash translation layer (FTL) 212, a flash interface layer (FIL) 213, a buffer memory 214, a throttling controller 215, and an error correction code (ECC) engine 216. The host interface layer 211, the flash interface layer 213, and the buffer memory 214 may be controlled by the flash translation layer 212.

The host interface layer 211 may be configured to transmit and to receive packets to and from the host 100. When the host 100 transmits a program request, a packet transmitted from the host 100 to the host interface layer 211 may include a command or data to be written to the memory device 220. When the host 100 transmits a read request, a packet transmitted from the host interface layer 211 to the host 100 may include a response to a command or data read from the memory device 220. The host interface layer 211 may transmit a request received from the host 100 to the flash translation layer 212.

The flash translation layer 212 may be configured to perform various operations or to generate commands and addresses in order to control the memory device 220. The flash translation layer 212 may generate various commands for program operations, read operations, erase operations, data compression operations, copyback operations, program progress status check operations, or the like, and generate addresses corresponding to the commands.

The flash translation layer 212 may be configured to control a program operation of the memory device 220 according to a program request of the host received from the host interface layer 211. For example, the flash translation layer 212 may generate a program command and a program address according to the program request of the host and transmit the same to the flash interface layer 213.

The flash translation layer 212 may be configured to control a read operation of the memory device 220 according to a read request of the host received from the host interface layer 211. The flash interface layer 213 may be configured to transfer data and information received from the memory device 220 to the flash translation layer 212.

The flash interface layer 213 may be configured to communicate with the memory device 220 using a communication protocol. For example, the flash interface layer 213 may be implemented to comply with a standard protocol, such as Toggle, Open NAND Flash Interface (ONFI), or the like.

The flash interface layer 213 may be configured to transmit an input/output command to the memory device 220. The memory device 220 may perform an input/output operation corresponding to the input/output command. The input/output command may include a command/address signal and/or data, etc. instructing the memory device 220 to perform an operation corresponding to the input/output command. The input/output command may be transmitted to the memory device 220 in the form of a stream, which is a set of input/output commands.

In at least one example embodiment, the memory controller 210 may be configured to transmit a plurality of streams to the memory device 220. The memory device 220 that has received the plurality of streams may process in parallel operations indicated by the input/output commands included in each of the plurality of streams. For example, each of the input/output commands may include different commands, addresses, and data.

The memory device 220 may be configured to perform input/output operations to store and/or erase data and/or to read out stored data and transmit the same externally. The flash interface layer 213 may store commands and addresses received from the flash translation layer 212 and transmit the stored commands and addresses to the memory device 220. The flash interface layer 213 may transmit data and information read out from the memory device 220 to the flash translation layer 212.

The buffer memory 214 may temporarily store data while the memory controller 210 controls the memory device 220. The buffer memory 214 may temporarily store data to be written to the memory device 220 or data read out from the memory device 220. The buffer memory 214 may be a component provided within the memory controller 210 but may also be disposed outside the memory controller 210.

The ECC engine 216 may be configured to perform an error detection and correction function for read data read from the memory device 220. More specifically, the ECC engine 216 may generate parity bits for write data to be written to the memory device 220, and the parity bits generated in this manner may be stored in the memory device 220 together with the write data. When reading data from the memory device 220, the ECC engine 216 may correct errors in the read data using the parity bits read from the memory device 220 together with the read data, and output error-corrected read data.

The temperature sensor 230 may be configured to measure an internal temperature of the storage device 200 and transmit the measured temperature to the memory controller 210. The memory controller 210 may perform throttling on the storage device 200 by activating the throttling controller 215 when the internal temperature of the storage device 200 is higher than a reference temperature. Accordingly, the internal temperature of the storage device 200 may be reduced below the reference temperature due to the throttling.

The throttling controller 215 may be configured to perform the throttling based on the current performance of the memory device 220. The input/output commands of each of the plurality of streams may be performed independently, and the memory device 220 may have different input/output throughputs (input/output per second (IOPS)) for each of the plurality of streams. The input/output throughput may be the number of input/output operations that the memory device 220 may process per unit time for each of the plurality of streams.

For example, a stream having a higher input/output throughput may have a larger impact on the increase in the internal temperature of the storage device 200. Meanwhile, a stream having a lower input/output throughput may have a smaller impact on the increase in the internal temperature of the storage device 200. Therefore, it delaying the input/output command for the stream having a high input/output throughput relatively more has a larger impact on the internal temperature.

In at least one example embodiment of the present inventive concepts, the throttling controller 215 may be configured to monitor the input/output throughput of each of the plurality of streams of the memory device 220 in real time. A typical throttling controller may collectively delay input/output commands of a plurality of streams without considering different input/output throughputs of the streams.

Thereby, the throttling controller 215 according to at least one example embodiment of the present inventive concepts may delay the input/output commands transmitted to each of the plurality of streams differently from each other based on the monitored input/output throughputs of each stream. Specifically, the input/output command may be significantly delayed for a stream having a relatively high input/output throughput, and the input/output command may not be delayed or may be slightly delayed for a stream having a low input/output throughput. Therefore, the temperature of the storage device 200 may be efficiently reduced, thereby improving the throttling efficiency.

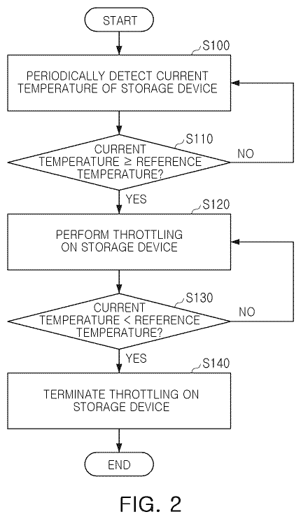

FIG. 2 is a diagram illustrating an operation of controlling the temperature of a storage device according to at least one example embodiment of the present inventive concepts.

The storage device may include a memory controller, a memory device, and a temperature sensor. The memory controller may include a throttling controller configured to perform the throttling on the storage device. Specific example embodiments of the storage device may be the same as or substantially similar to those described above with reference to FIG. 1.

The memory controller may periodically detect the current temperature of the storage device using output of the temperature sensor (S100). For example, in at least some embodiments, the memory controller may be configured to detect the current temperature based on at least one of a timer or a clock signal. The current temperature of the storage device may correspond to the current internal temperature of the storage device. The memory controller may compare the current temperature of the storage device with a reference temperature (S110). Here, the reference temperature may be a specific temperature used as a reference for triggering or terminating throttling for the storage device. For example, the reference temperature may be 100° C. (Celsius temperature scale), but is not limited thereto.

If the current temperature of the storage device is equal to or lower than the reference temperature (NO of S110), throttling for the storage device is not performed and the current temperature of the storage device may be continuously detected (S110).

If the current temperature of the storage device is higher than the reference temperature (YES of S110), the throttling controller may throttle (e.g., perform throttling for) the storage device (S120). According to at least one example embodiment of the present inventive concepts, the throttling controller may delay input/output commands transmitted to each of the plurality of streams differently based on the monitored input/output throughput corresponding to each stream.

If the current temperature of the storage device is higher than the reference temperature (NO of S130), the throttling controller may continue to perform the throttling on the storage device (S120). If the current temperature of the storage device is lower than the reference temperature (YES of S130), the throttling controller may terminate throttling on the storage device (S140).

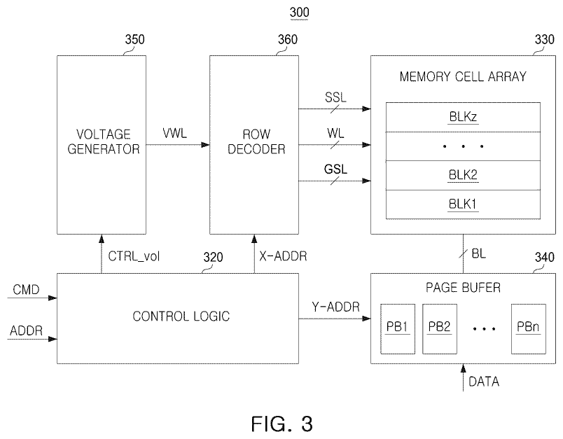

Hereinafter, before specifically illustrating the throttling controller according to at least one example embodiment of the present inventive concepts, a memory device will be described in detail with reference to FIGS. 3 to 5.

FIG. 3 is a block diagram illustrating a memory device according to at least one example embodiment of the present inventive concepts.

Referring to FIG. 3, a memory device 300 may include a control logic circuit 320, a memory cell array 330, a page buffer 340, a voltage generator 350, and a row decoder 360. Although not illustrated in FIG. 2, the memory device 300 may further include a memory interface circuit configured to receive a command CMD and an address ADDR from an external source and exchanging data DATA with the external source and may further include a column logic, a pre-decoder, a temperature sensor, a command decoder, an address decoder, etc. Here, a single input/output command received in a single stream of the memory device from a memory controller may include a command CMD and an address ADDR received from the external source and data DATA exchanged with the external source.

The control logic circuit 320 may be configured to control various operations within the memory device 300 overall. The control logic circuit 320 may output various control signals in response to the command CMD and/or the address ADDR from the memory interface circuit 310. For example, the control logic circuit 320 may output a voltage control signal CTRL_vol, a row address X-ADDR, and a column address Y-ADDR.

The memory cell array 330 may include a plurality of memory blocks BLK1 to BLKz (z is a positive integer), and each of the plurality of memory blocks BLK1 to BLKz may include a plurality of memory cells. The memory cell array 330 may be connected to the page buffer 340 via bit lines BL and may be connected to the row decoder 360 via word lines WL, string select lines SSL, and ground select lines GSL.

For example, the memory cell array 330 may include a three-dimensional (3D) memory cell array, and the 3D memory cell array may include a plurality of NAND strings. Each NAND string may include memory cells each connected to word lines vertically stacked on the substrate. In at least one example embodiment, the memory cell array 330 may include a two-dimensional (2D) memory cell array, and the 2D1 memory cell array may include a plurality of NAND strings arranged in row and column directions.

The page buffer 340 may include a plurality of page buffers PB1 to PBn (n is an integer of 3 or greater), and the plurality of page buffers PB1 to PBn may be respectively connected to the memory cells through a plurality of bit lines BL. The page buffer 340 may select at least one bit line among the bit lines BL in response to the column address Y-ADDR. The page buffer 340 may operate as a write driver or a sense amplifier depending on an operation mode. For example, during a program operation, the page buffer 340 may apply a bit line voltage corresponding to data to be programmed to the selected bit line. During a read operation, the page buffer 340 may detect data stored in the memory cell by detecting a current or voltage of the selected bit line.

The voltage generator 350 may be configured to generate various types of voltages for performing program, read, and erase operations based on the voltage control signal CTRL_vol. For example, the voltage generator 350 may generate a program voltage, a read voltage, a program verification voltage, an erase voltage, etc. as a word line voltage VWL.

The row decoder 360 may select one of a plurality of word lines WL and one of a plurality of string selection lines SSL in response to the row address X-ADDR. For example, during a program operation, the row decoder 360 may apply a program voltage and a program verification voltage to a selected word line, and during a read operation, the row decoder 360 may apply a read voltage to a selected word line.

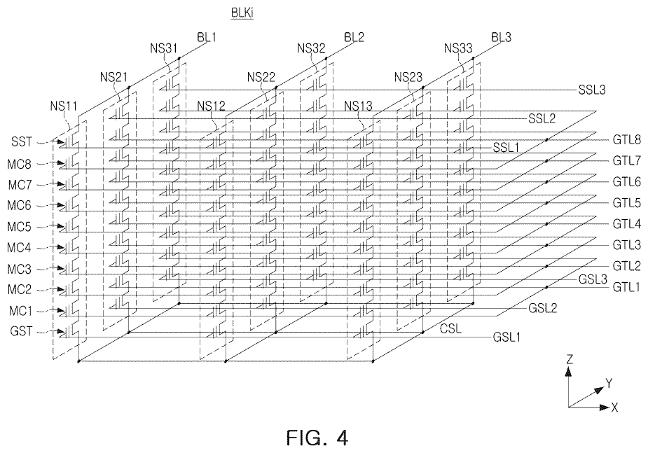

FIG. 4 is a diagram illustrating a 3D V-NAND structure that may be applied to a storage device according to at least one example embodiment of the present inventive concepts.

Referring to FIG. 4, when a memory device of a storage device is implemented as a 3D V-NAND type flash memory, each of a plurality of memory blocks constituting the memory device may be expressed as an equivalent circuit as illustrated in FIG. 4.

Referring to FIG. 4, a plurality of memory NAND strings included in a memory block BLKi may be formed in a direction, perpendicular to the substrate. The memory block BLKi may include a plurality of memory NAND strings NS11 to NS33 connected between bit lines BL1, BL2, and BL3 and a common source line CSL. Each of the plurality of memory NAND strings NS11 to NS33 may include a string select transistor SST, a plurality of memory cells MC1, MC2, . . . , MC8, and a ground select transistor GST. Although FIG. 4 illustrates that each of the plurality of memory NAND strings NS11 to NS33 includes eight memory cells MC1, MC2, . . . , MC8, it is not necessarily limited thereto.

The string select transistor SST may be connected to corresponding string select lines SSL1, SSL2, and SSL3, respectively. The plurality of memory cells MC1, MC2, . . . , MC8 may be connected to corresponding gate lines GTL1, GTL2, . . . , GTL8, respectively. The gate lines GTL1, GTL2, . . . , GTL8 may correspond to word lines, and some of the gate lines GTL1, GTL2, . . . , GTL8 may correspond to dummy word lines. The ground select transistor GST may be connected to corresponding ground select line GSL1, GSL2, and GSL3. The string select transistor SST may be connected to corresponding bit line BL1, BL2, and BL3, and the ground select transistor GST may be connected to the common source line CSL. Word lines of the same height (e.g., WL1) may be commonly connected, and the ground selection lines GSL1, GSL2, and GSL3 and the string selection lines SSL1, SSL2, and SSL3 may be separated. In FIG. 3, the memory block BLK is illustrated as being connected to eight gate lines GTL1, GTL2, . . . , GTL8 and three bit lines BL1, BL2, and BL3, but is not necessarily limited thereto.

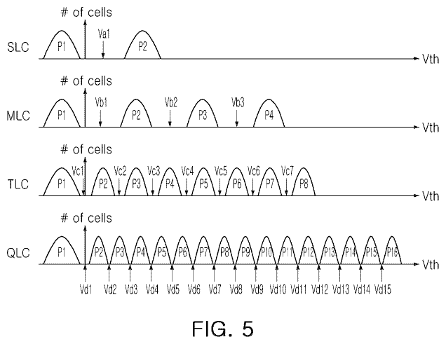

FIG. 5 is a diagram illustrating a threshold voltage distribution of a memory cell according to at least one example embodiment of the present inventive concepts.

Referring to FIG. 5, the horizontal axis of each graph represents the magnitude of a threshold voltage, and the vertical axis represents the number of memory cells. The storage device may include a plurality of different memory types. For example, the memory types may include one or more of a single level cell-type, a multiple level cell-type, a triple level cell-type, a quadruple level cell-type, etc.

When a memory cell is a single level cell (SLC) storing 1-bit data, the memory cell may have a threshold voltage corresponding to one of a first program state P1 or a second program state P2. The read voltage Va1 may be a read voltage for distinguishing between the first program state P1 and the second program state P2. A memory cell having the first program state P1 may be read as an ON cell since it has a threshold voltage lower than the read voltage Va1. A memory cell having the second program state P2 may be read as an OFF cell since it has a threshold voltage higher than the read voltage Va1.

When the memory cell is a multiple level cell (MLC) storing 2-bit data, the memory cell may have a threshold voltage corresponding to one of the first program state to fourth program state P1 to P4. The first to third read voltages Vb1 to Vb3 may be read voltages for distinguishing between the first program state to the fourth program state P1 to P4, respectively. The first read voltage Vb1 may be a read voltage for distinguishing between the first program state P1 and the second program state P2. The second read voltage Vb2 may be a read voltage for distinguishing between the second program state P2 and the third program state P3. The third read voltage Vb3 may be a read voltage for distinguishing between the third program state P3 and the fourth program state P4.

When the memory cell is a triple level cell (TLC) storing 3-bit data, the memory cell may have a threshold voltage corresponding to any one of the first to eighth program states P1 to P8. The first to seventh read voltages Vc1 to Vc7 may be read voltages for distinguishing between the first to eighth program states P1 to P8, respectively. The first read voltage Vc1 may be a read voltage for distinguishing between the first program state P1 and the second program state P2. The second read voltage Vc2 may be a read voltage for distinguishing between the second program state P2 and the third program state P3. In the same manner, the seventh read voltage Vc7 may be a read voltage for distinguishing between the seventh program state P7 and the eighth program state P8.

When the memory cell is a quadruple level cell (QLC) storing 4-bit data, the memory cell may have any one of the first to sixteenth program states P1 to P16. The first to fifteenth read voltages Vd1 to Vd15 may be read voltages for distinguishing between the first to sixteenth program states P1 to P16, respectively. The first read voltage Vd1 may be a read voltage for distinguishing between the first program state P1 and the second program state P2. The second read voltage Vd2 may be a read voltage for distinguishing between the second program state P2 and the third program state P3. In the same manner, the fifteenth read voltage Vd15 may be a read voltage for distinguishing between the fifteenth program state P15 and the ¹6th program state P16.

However, these are examples, only the types of memory cells are not limited thereto.

A memory controller according to at least one example embodiment of the present inventive concepts may independently control the same memory cell by separating it into different regions. Hereinafter, an automotive storage device included in an automotive device will be described as at least one example embodiment of the present inventive concepts.

For example, when a memory device includes the memory cells of two or more of SLC, MLC, TLC, and QLC, the memory controller may independently control an SLC memory cell region, an MLC memory cell region, a TLC memory cell region, and a QLC memory cell region by separating them. The memory controller may transmit input/output commands to each of the plurality of memory cell regions through different streams.

In at least one example embodiment of the present inventive concepts, the memory controller may monitor an input/output throughput for each of the plurality of memory cell regions in real time. Based on the monitored input/output throughput for each memory cell region, the memory controller may delay the input/output commands transmitted to each of the plurality of memory cell regions through different streams differently from each other.

For example, when the input/output throughput of the SLC memory cell region is relatively high, the input/output commands transmitted to the SLC memory cell region may be delayed relatively more. The temperature of the SLC memory cell region, having a large impact on the increase in the internal temperature of the storage device, may be reduced more significantly. As another example, when the input/output throughput of the QLC memory cell region is relatively low, the input/output command transmitted to the QLC memory cell region may be delayed relatively less. The temperature of the QLC memory cell region, which has a relatively small impact on the increase in the internal temperature of the storage device, may be reduced relatively less. Therefore, the internal temperature of the storage device may be efficiently controlled.

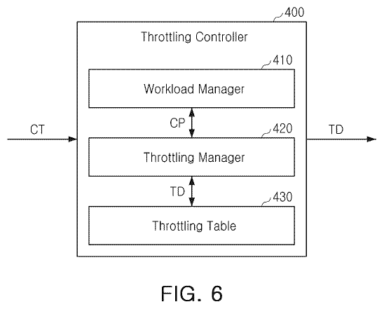

FIG. 6 is a block diagram schematically illustrating a throttling controller according to at least one example embodiment of the present inventive concepts.

The storage device may include a memory controller, a memory device, and a temperature sensor. In this case, the storage device may be included in an automotive device. The memory controller may include a throttling controller 400 performing throttling on the storage device. The memory controller may periodically detect the current temperature of the storage device using an output of the temperature sensor. Specific embodiments of the storage device may be the same as or substantially similar to those described above with reference to FIGS. 1 to 5.

If the current temperature of the storage device is higher than the reference temperature, the throttling controller 400 may perform throttling on the storage device. First, referring to FIG. 6, the throttling controller 400 may include a workload manager 410, a throttling manager 420, and a throttling table 430.

The workload manager 410 may periodically monitor the current performance CP of each of the plurality of streams. In this case, the current performance CP may include input/output throughput. The workload manager 410 may transmit monitoring results to the throttling manager 420.

The throttling manager 420 may determine (e.g., calculate) a target delay value TD to delay the input/output commands transmitted to each of the plurality of streams, based on the monitored current performance CP of each of the plurality of streams. Here, the target delay value TD may be a value applied by the memory controller to delay the input/output transmission through each of the plurality of streams. The target delay value TD may correspond to the amount of change in a waiting time between the input/output commands or the amount of change in the transmission period of the input/output commands, but the type of the target delay value TD may not be limited thereto.

The target delay value TD determined by the throttling manager 420 may be transmitted to and stored in the throttling table 430.

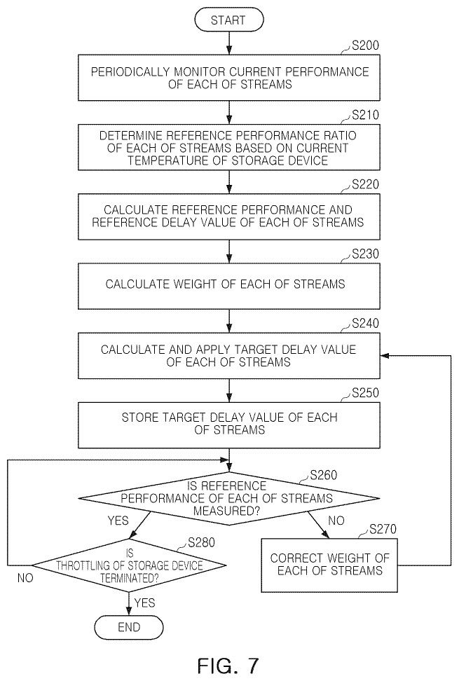

Hereinafter, the process of calculating the target delay value TD will be described in detail with reference to FIGS. 7 to 9.

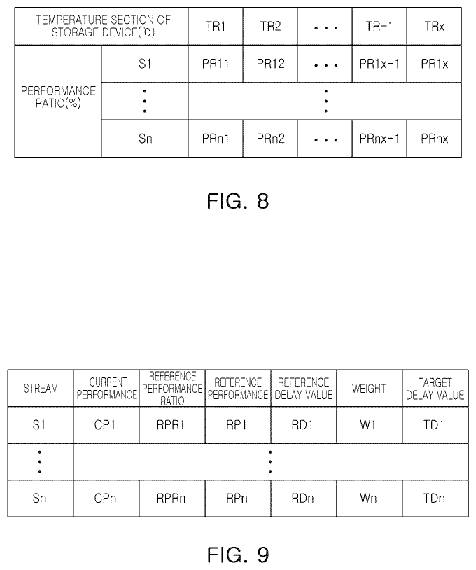

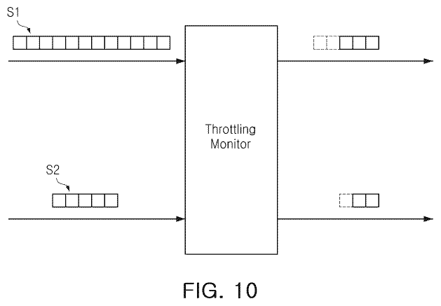

FIG. 7 is a flowchart illustrating throttling performance of a throttling controller according to at least one example embodiment of the present inventive concepts. FIG. 8 is a diagram illustrating a performance ratio by stream according to a temperature range of a storage device according to at least one example embodiment of the present inventive concepts. FIG. 9 is a diagram illustrating calculation of a target delay value by stream according to at least one example embodiment of the present inventive concepts.

First, referring to FIG. 7, the workload manager may periodically monitor the current performance of each of a plurality of streams (S200). For example, the workload manager may monitor the current performance based on at least one of a timer or a clock signal. Here, the workload manager may monitor the current performance after throttling performance starts or continuously monitor the current performance regardless of throttling performance. In at least one example embodiment, the workload manager may calculate the input/output throughput processed by each of a plurality of streams for 1 second as the current performance of the corresponding stream. However, the type and period of the performance are not limited thereto.

The throttling manager may receive the periodically detected current temperature CT of the storage device. The throttling manager may determine (e.g., calculate) a reference performance ratio of each of the plurality of streams, based on the current temperature CT of the storage device (S210).

Referring to FIG. 8, FIG. 8 may represent the performance ratio PR of each of the plurality of streams S1 to Sn for a temperature section TR of the storage device. The performance ratio PR for the temperature section TR may be data determined in advance in a design stage and/or a test stage of the storage device. The data for the temperature section TR and the performance ratio PR of the storage device may be stored in the throttling controller or the memory controller in a diagram format as illustrated in FIG. 8, but the format and/or storage location of the data are not limited thereto.

The size of the temperature section TR of the storage device may be greater than the size of the reference temperature of the storage device. The size of each of first to x-th temperature sections TR1 to TRn may be the same, or the size of at least one of the first to x-th temperature sections TR1 to TRn may be different. The first temperature section TR1 may represent a section with the lowest temperature, and the x-th temperature section TRx may represent a section with the highest temperature. Therefore, the temperature may increase from the first temperature section TR1 to an n-th temperature section TRn.

The performance ratio PR may represent a ratio to a performance maximum (herein a “maximum performance”), and the unit may be % (percentage). The performance ratio PR may represent the ratio of each of the plurality of streams S1 to Sn to the maximum performance. For example, the performance ratio PR may have a value less than or equal to a hundred (100). However, the size of the performance ratio PR are not limited thereto.

For example, when the current temperature CT of the storage device corresponds to the first temperature section TR1, the performance of the first stream S1 may be controlled to change to an eleventh performance ratio RP11 and the performance of the n-th stream Sn may be controlled to change to a (n+1)-th performance ratio RPn1. The throttling manager may determine a section among the first to x-th temperature sections TR1 to TRx to which the current temperature CT corresponds and determine the performance ratio PR of the corresponding section as a reference performance ratio RPR for each stream.

Referring to FIG. 9, the current performance of each of the plurality of streams S1 to Sn may correspond to the first to n-th current performances CP1 to CPn. The first current performance CP1 may refer to the number of input/output commands processed by the memory device for the first stream for a predetermined period of time. For example, the current performance CP may represent the number of input/output commands for a stream to which the memory device corresponds for one (1) second. The first to n-th reference performance ratios RPR1 to RPRn of each of the plurality of streams S1 to Sn may be the reference performance ratio determined with reference to FIG. 8 above.

Referring to FIGS. 7 and 9, the throttling manager may determine the reference performance RP and a reference delay value RD for each of the plurality of streams S1 to Sn (S220). The reference performance RP for each of the plurality of streams S1 to Sn may be determined (e.g., calculated) as, or based on, the product of the current performance CP and the reference performance ratio RPR. The reference performance RP may be equal to or greater than the minimum performance of the stream S. The minimum performance may be the minimum number of input/output commands that is to be executed per unit time among the input/output commands of each of the plurality of streams S1 to Sn.

The reference delay value RD may correspond to a difference between the reference performance RP and the current performance CP. The current performance CP of each of the plurality of streams S1 to Sn may be the maximum performance of each stream.

For example, the reference delay value RD may be a value added to the period of an input/output command, and the transmission period of the input/output command transmitted by the memory controller to the memory device may be changed by the reference delay value RD. At least one of the first to n-th reference delay values RD1 to RDn for the plurality of streams S1 to Sn may be different.

The throttling manager may determine weights W1 to Wn of each of the plurality of streams S1 to Sn (S230). Each of the weights W1 to Wn may be calculated using the first to n-th reference performances RP1 to RPn. In at least one example embodiment of the present inventive concepts, the weights W1 to Wn of each of the plurality of streams S1 to Sn may represent a ratio of the current performance of the corresponding stream to the total (e.g., a sum) of the current performance CP1 to CPn or a total reference performance (e.g., a sum of the first to n-th reference performances RP1 to RPn). For example, in at least one example embodiment, if the first current performance CP1 accounts for 70% of the total current performance CP1 to CPn, the first weight W1 may be 0.7. The sum of the first to n-th weights W1 to Wn may be 1.

The throttling manager may determine and apply a target delay value TD of each of the plurality of streams S1 to Sn by reflecting the weights W1 to Wn on the reference delay values RD1 to RDn (S240). In at least one example embodiment, the target delay value TD may be a value obtained by applying the weight W to the reference delay value RD. In an example, if the first weight W1 is 0.7, the first target delay value TD1 may be 0.7 times the first reference delay value RD1. Each of the first to n-th target delay values TD1 to TDn calculated by the throttling manager may be applied to the corresponding stream S, so that the transmission period of the input/output command transmitted through the stream may be varied by the target delay value TD. Therefore, the target delay value TD may be a change amount of the transmission period of the input/output command.

The throttling manager may transmit the calculated first to n-th target delay values TD1 to TDn to the throttling table. The throttling table may store the first to n-th target delay values TD1 to TDn (S250). For example, the first to n-th target delay values TD1 to TDn respectively corresponding to the first to n-th streams S1 to Sn may be stored in the throttling table in a table format. However, the storage format and/or location of the data are not limited thereto.

Even after the target delay values TD1 to TDn are reflected, the workload manager may periodically monitor the current performance CP of each of the plurality of streams S1 to Sn and transmit the same to the throttling manager. The throttling manager may determine whether the reference performance RP is measured in each of the plurality of streams S1 to Sn (S260). Here, the reference performances RP1 to RPn may be the result determined in the previous operation S220.

If the reference performances RP1 to RPn are measured in each of the plurality of streams S1 to Sn (YES in S260), the throttling manager may determine whether the throttling of the storage device is terminated (S280). The throttling manager may apply the first to n-th target delay values TG1 to TGn until the throttling of the storage device is terminated, and continue to determine whether the reference performance RP is measured.

If the reference performances RP1 to RPn are not measured respectively in the plurality of streams S1 to Sn (NO in S260), the throttling manager may correct the respective weights W1 to Wn of the plurality of streams S1 to Sn (S270). For example, when the current performance in each of the plurality of streams does not fall within a tolerance range for the reference performance, the throttling manager may correct the weights corresponding to the plurality of streams falling outside the tolerance range. The sum of the first to n-th weights W1 to Wn is maintained constant, and some of the first to n-th weights W1 to Wn may be increased or decreased within a predetermined range. In at least one example embodiment, the first weight W1 may be increased by 5%, and the n-th weight Wn may be decreased by 5%. However, the present inventive concepts may not be limited thereto.

The throttling manager may repeatedly perform the processes of determining and applying the target delay value TD of each of the plurality of streams S1 to Sn by reflecting the corrected weights on the reference delay values RD1 to RDn calculated in operation S220 and determining whether the reference performance RP is measured (S240 to S260). The above processes may be repeated until a reference performance RP is measured in each of the plurality of streams S1 to Sn.

According to at least one example embodiment of the present inventive concepts, a delay time of the input/output transmission period (e.g., when the reference performance RP is determined in each of the plurality of streams S1 to Sn) may be determined (e.g., calculated) as the target delay value TD of each of the plurality of streams S1 to Sn. In determining the target delay value TD, the reference performance RP and the weight W may be reflected, and the reference performance RP may be equal to or greater than the minimum performance of each stream S. The minimum performance may be the minimum number of input/output commands that have to be executed per unit time among the input/output commands of each of the plurality of streams S1 to Sn.

In other words, when performing throttling on the storage device, the minimum performance of each of the plurality of streams may be maintained. In addition, by reflecting the weight for the current performance of each of the plurality of streams, the input/output commands transmitted through each of the plurality of streams may be delayed differently. Therefore, the efficiency of reducing the temperature of the storage device may be improved by delaying the input/output command for the stream that has a larger impact on the temperature increase of the storage device relatively more.

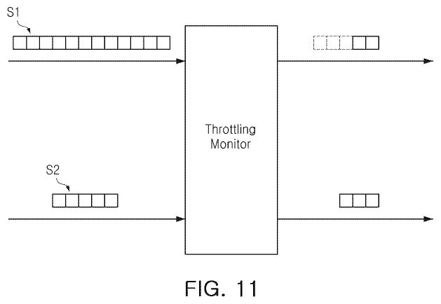

FIGS. 10 and 11 are diagrams illustrating a transmission period of input/output commands of embodiments of the present inventive concepts.

The storage device may include a memory controller, a memory device, and a temperature sensor. The memory controller may include a throttling controller performing throttling on the storage device. The memory controller may periodically detect the current temperature of the storage device using the output of the temperature sensor. The throttling controller may include a workload manager, a throttling manager, and a throttling table. Specific embodiments of the storage device may be the same as or substantially similar to those described above with reference to FIGS. 1 to 9.

According to at least one example embodiment of the present inventive concepts, the throttling manager may calculate a target delay value for delaying the transmission period of the input/output command transmitted to each of the plurality of streams, based on current performance of the memory device for each of the plurality of monitored streams. Here, the target delay value may correspond to the amount of change in the transmission period of the input/output command for each of the plurality of streams.

According to the embodiment illustrated in FIGS. 10 and 11, the memory device may receive input/output commands included in each of the first and second streams S1 and S2 and may process in parallel the operations indicated by the input/output commands. If the current temperature of the storage device is higher than the reference temperature and throttling is performed, the throttling controller may delay the transmission period of the input/output commands for each of the first and second streams S1 and S2. Each of the first and second streams S1 and S2 may include input/output commands transmitted by a host to the storage device and/or input/output commands generated by the flash translation layer 212.

Referring to FIGS. 10 and 11, the number of input/output commands transmitted per unit time for each of the first and second streams S1 and S2 may be indicated. Before throttling is performed, five input/output commands may be transmitted per unit time for the first stream S1, and three input/output commands may be transmitted per unit time for the second stream S2. The throttling controller may delay the transmission periods of the input/output commands for the first and second streams S1 and S2.

First, referring to FIG. 10, the throttling controller may determine a target delay value for each of the first and second streams S1 and S2. According to the example illustrated in FIG. 10, the target delay value of the first stream S1 may be 2, and the target delay value of the second stream S2 may be 1. In other words, the input/output command transmission period of the first stream S1 may be reduced by 2, and the input/output command transmission period of the second stream S2 may be reduced by 1.

Referring to FIG. 11, the throttling controller may calculate the target delay value only for the first stream S1. According to the example illustrated in FIG. 11, the target delay value TD1 of the first stream S1 may be 3, and the target delay value TD2 of the second stream S2 may be 0. Here, the current performance of the second stream S2 may be the minimum performance. The minimum performance may be the minimum number of input/output commands that have to be executed per unit time among the input/output commands included in the second stream S2. Therefore, the throttling controller may not delay the input/output command transmission period of the second stream S2.

According to at least one example embodiment of the present inventive concepts, when the current temperature of the storage device is higher than the reference temperature, a temperature control operation of the storage device may be performed. The memory controller may delay the input/output commands transmitted to each of the plurality of streams differently from each other based on the current input/output throughput of each of the plurality of streams. Therefore, the temperature control efficiency of the storage device may be improved.

While some example embodiments have been illustrated and described above, it will be apparent to those skilled in the art that modifications and variations could be made without departing from the scope of the present inventive concepts as defined by the appended claims.

What is claimed is:

1. A temperature throttling method of a storage device, the temperature throttling method comprising:
monitoring current performance of a memory device, the memory device operating in response to input/output commands respectively included in a plurality of streams;
determining, based on a current temperature of the storage device, a reference performance and a reference delay value for each of the plurality of streams;
determining, based on the current performance, a weight for each of the plurality of streams;
determining a target delay value, for each of the plurality of streams, by reflecting the weight on the reference delay value; and
applying the weight, for which the reference performance is measured, in each of the plurality of streams.

2. The temperature throttling method of claim 1, wherein the monitoring the current performance includes monitoring an input/output throughput of the memory device for each of the plurality of streams.

3. The temperature throttling method of claim 1, wherein the determining of the reference performance and the reference delay value for each of the plurality of streams includes:
determining a reference performance ratio of each of the plurality of streams for a section corresponding to the current temperature of the storage device; and
determining the reference performance using the current performance and the reference performance ratio for each of the plurality of streams.

4. The temperature throttling method of claim 3, wherein the reference performance based on a product of the current performance and the reference performance ratio and is equal to or greater than a minimum performance.

5. The temperature throttling method of claim 3, wherein the reference delay value is based a difference between the reference performance and the current performance.

6. The temperature throttling method of claim 1, wherein the weight of each of the plurality of streams is based a ratio of the reference performance of each of the plurality of streams to a total reference performance.

7. The temperature throttling method of claim 6, wherein the total reference performance is based a sum of the weights of the plurality of streams.

8. The temperature throttling method of claim 6, wherein a sum of the weights of each of the plurality of streams is one (1).

9. The temperature throttling method of claim 1, wherein the target delay value is obtained by applying the weight to the reference delay value.

10. The temperature throttling method of claim 1, wherein the target delay value includes an amount of change in a transmission period of each of the input/output commands.

11. The temperature throttling method of claim 1, further comprising:
delaying a transmission period of at least one of the input/output commands by applying the target delay value to a corresponding stream from among the plurality of streams.

12. The temperature throttling method of claim 1, wherein the applying the weight includes, for each of the plurality of streams:
repeatedly monitoring the current performance by applying the target delay value; and
correcting the weight when the current performance does not fall within a certain range of the reference performance.

13. The temperature throttling method of claim 1, wherein the plurality of streams respectively correspond to memory cell regions including different types of memory cells.

14. The temperature throttling method of claim 13, wherein the different types of the memory cells include two or more of single level cell, multiple level cell, triple level cell, or quadruple level cell.

15. A temperature throttling method of an automotive storage device, the temperature throttling method comprising:
determining, based on a current temperature of the automotive storage device, a reference performance ratio for each of a plurality of streams;
determining a reference performance by multiplying a current performance by the reference performance ratio for each of the plurality of streams;
determining a reference delay value for each of the plurality of streams based on a difference between the current performance and the reference performance;
determining a weight for each of the plurality of streams based on a ratio of the current performance corresponding to each of the plurality of streams to a sum of current performances of the plurality of streams;
determining a target delay value for each of a corresponding stream, of the plurality of streams, by applying the weight to the reference delay value; and
applying, for each of the plurality of streams, the target delay value to the corresponding stream.

16. The temperature throttling method of claim 15, wherein the current performance includes an input/output throughput for each of the plurality of streams.

17. The temperature throttling method of claim 15, further comprising:
delaying a transmission period of an input/output command by applying the target delay value to the corresponding stream.

18. The temperature throttling method of claim 15, wherein the plurality of streams respectively correspond to memory cell regions including different types of memory cells.

19. The temperature throttling method of claim 18, wherein the types of the memory cells include at least one of single level cell, multiple level cell, triple level cell, or quadruple level cell.

20. A temperature throttling method of a storage device, the temperature throttling method comprising:
starting a throttling of the storage device based on a determination that a current temperature of the storage device is higher than a reference temperature;
monitoring input/output throughputs for each of a plurality of streams;
determining delay times of input/output transmission periods applied to each of the plurality of streams by reflecting the current temperature of the storage device and the input/output throughputs for each of the plurality of streams;
applying a delay time, of the delay times, to a corresponding stream of the plurality of streams; and
terminating throttling for the storage device based on a determination that the current temperature of the storage device is lower than the reference temperature,
wherein at least a portion of the delay times of the input/output transmission periods applied to the plurality of streams differ from at least a portion of a remainder of the delay times of the input/output transmission periods.
